(19) United States
(12) Patent Application Publication
(10) Pub. No.: US 2007/0226604 A1
(43) Pub. Date: Sep. 27, 2007

(54) System and method for merging a sub-document into a collaboratively authored master document

(76) Inventors: Nanchariah R. Chalasani, Fairfax, VA (US); Pamela S. Helyar, Morrisville, NC (US); Hari Shankar, Morrisville, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/386,886

(22) Filed: Mar. 22, 2006

(51) Int. Cl. G06F 17/00; G06F 17/30; G06F 3/00

(52) U.S. Cl. 715/500; 715/530; 715/513; 707/3; 715/751

(57) ABSTRACT

The “Collaborative Document Merge Tool” or “CDMT” is a computer-implement process and accompanying product for merging a sub-document into a master document, the process comprising: identifying an author of the sub-document; reading metadata that specifies an authorized author of the sub-document; comparing the author to the authorized author, and merging the sub-document into the master document only if the author is identical to the authorized author.

### FIELD OF THE INVENTION

The present invention relates generally to presentation processing of documents and specifically to version management of documents.

### BACKGROUND OF THE INVENTION

Collaborative document authoring is now more a norm than an exception in any line of business, be it technology, law, education, research or journalism. Typically, several individuals author different sections of a document based on their assigned roles and their individual area of expertise. An individual then merges the sections together. Typically, one individual is responsible for the document as a whole, and that individual oversees and coordinates the authorship of the different parts of the document. This effort of collaboratively creating the document involves several iterations, where a partially written document passes to various authors for work on their respective section. Each completed section returns to the document coordinator for merger into the master copy. Coordinating a collaboratively authored document involves a non-trivial amount of effort in terms of tracking different versions of each section by each author, and merging the different versions of document sections into the maser document

To further complicate the process of coordinating a collaboratively authored document, there a various media trough which people communicate during the writing process, such as email and chat The records of author's communications related to the document or actual content intended for the final product often comprise different mediums or formats tan that of the master document Often, authors want to capture content from a chat transcript or email message and merge the content into the master document

Because of the complex nature of collaborative document authorship, the coordinator responsible for merging the document must send significant time sad effort to track different versions of the document he receives from the individual authors. Furthermore, the coordinator must exert considerable effort to carefully extract specific sections written by the appropriate authors from the correct version of their documents, for inclusion in the muter document.

Currently there are no known solutions that help authors collaborating on documents in smartly merging the different pieces written by individual authors. Existing products used for collaborative authoring are described as follows. MICROSOFT WORD contains feature for document merge, but these features function more as a ‘document append’, where multiple documents can be appended together to form a single document. MICROSOFT WORD also pits some merging based on the ‘track changes’ feature. Such solutions do not elegantly aid someone merging different sections of a document authored by several author; wherein multiple versions of each section written by different authors cannot be merged by simply appending together all the parts. ADOBE uses a third party plugin available with the append feature as described above for MICROSOFT WORD. Neither of these solutions allow the coordinator of the collaboratively authored master document to pre-define “approved”, authors for each section of the master document. Also, neither solution automatically merges content extracted from other media types such as internet chat transcripts or e-mail messages.

A need exists for a method of automatically exacting authorized content from sub-documents created by various collaborating authors and merging the content into a master document.

### SUMMARY OF THE INVENTION

The invention meeting the need described above is the “Collaborative Document Merge Tool” or “CDMT”. The CDMT, described in detail below, is a computer-implement process and accompanying products for merging a sub-document into a master document, the process comprising: identifying an author of the sub-document; reading metadata that specifies an authorized author of the sub document; comparing the author to the authorized author; and merging the sub-document into the master document only if the author is identical to the authorized author.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the follow detailed description of an illustrative embodiment when read in conjunction with the accompanying drawings, wherein:

FIG. 1 represents an exemplary computer network.

FIG. 2 describes programs and files in memory on a computer.

FIG. 3 is a flow chart of the Specification Component.

FIG. 4 is a flow chart of the Merge Component.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing or displaying data, and includes without limitation and memory; the term “computer software” or “software,” refers to any set of instructions operable to cause computer hardware to perform an operation. A “computer,” as that term is used herein, includes without limitation any useful combination of hardware and software, and a “computer program” “program” includes without limitation any software operable to cause computer hardware to accept, perform logic operations on, store, or display data A computer program may, and often is, comprised of a plurality of smaller programming units, including without limitation subroutines, modules, functions, methods, and procedures. Thus, the functions of the present invention may be distributed among a plurality of computers and computer programs. The invention is described best, though as a single computer program that configures and enables one or more general-purpose computers to implement the novel aspects of the invention. For illustrative purposes, the inventive computer program will be referred to as the “Collaborative Document Merge Tool” or “CDMT”.

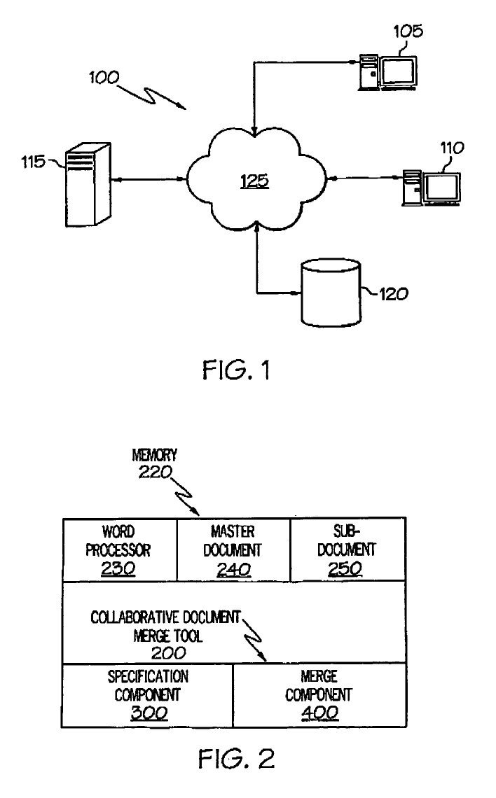

Additionally, the CDMT is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 103, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

CDMT 200 typically is stored in a memory, Resented schematically as memory 220 in FIG.2. The term “memory,” as used herein, includes without limitation any volatile or persistent medium, such as an electrical circuit, magnetic disk, or optical disk, in which a computer can store data or software for any duration. A single memory may encompass and be distributed across a plurality of media Thus, FIG. 2 is included merely as a descriptive expedient and does not necessarily reflect any particular physical embodiment of memory 220. As depicted in FIG. 2, though, memory 220 may include additional data and programs. Of particular import to CDMT 200, memory 220 may include Word Processor 230, Maser Document 240 and Sub-Document 250 with which CDMT 200 interacts.

Master Document 240 may have restricted permissions or access rights through Word Processor 230, the network's file system or the computer's operating system. The coordinator, CDMT 200 and its components would all have the proper permissions or access rights to modify Master Document 240. Master Document 240 in its preferred form is a document file compatible with word processor 230. Sub-Document 250 may be any text or data file such as an internet chat transcript or an e-mill message, and need not necessarily be compatible with word processor 230.

CDMT 200 has two components: Specification Component 300 and Merge Component 400. The coordinator of a collaboratively authored Master Document 240 uses Specification Component 300 to assign the names of authors authorized to modify the various sections of Master Document 240. Merge Component 400 merges content created only by authorized authors of Sub-Document 2 with aster Document 240.

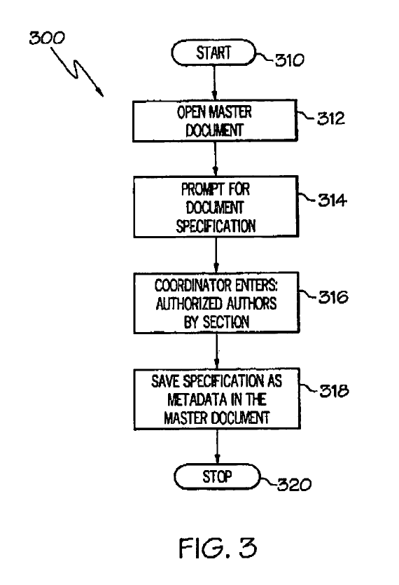

FIG. 3 is a flowchart of Specification Comport 300. The coordinator of collaboratively authored Mast Document 240 starts Specification Component 300 (310) to assign authorized authors to each section of Master Document 240. Specification Component 300 opens Master Document 240, including any metadata associated with Master Document 240 (312). Specification Component 300 prompts the coordinator to specify authorized authors for each section of Master Document 240 (314). The coordinator enters the names of the authorized author or authors for each section of Mar Document 240 (316). The coordinator may optionally specify names of editors or coordinators who have authorization to modify the entire content or formatting of Master Document 240. After the coordinator completes the specifications, Specification Component 300 saves the specifications as metadata in aster Document 240 (318) and stops (320).

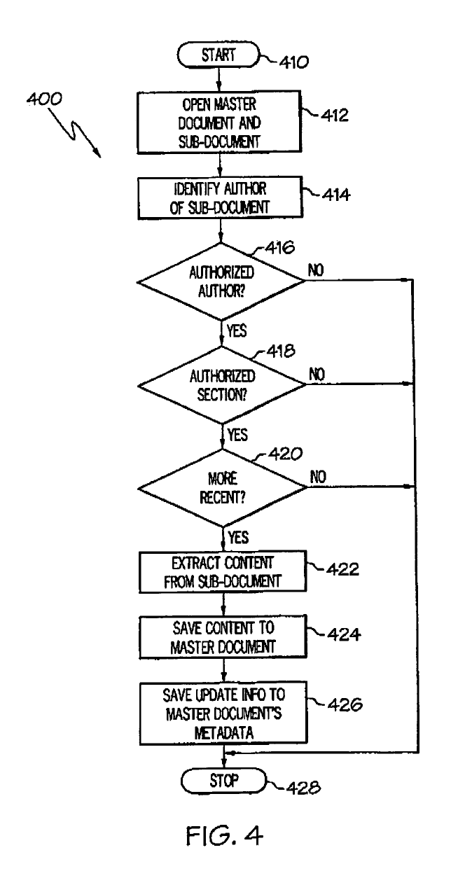

FIG. 4 is a flowchart of Merge Component 400. Merge Component 400 starts when initiated by the coordinator (410). Optionally, Merge Component 400 may star automatically when Sub-Document 250 is sent to or saved in a designated memory location, such as a folder, directory or e-mail address. Merge Component 400 opens both Master Document 240 and Sub-Document 250, including any metadata associated with either document (412). Merge Component 400 identifies the author of Sub-Document 250 (414). Using the information saved in the metadata of Master Document 240, Merge Component 400 verifies: that the author of Sub-Document 250 is authorized to make an update (416); than the content of Sub-Document 250 contains changes to authorized sections of Master Document 240 (418), and tat Sub-Document 250 contains changes that are more recent than any previously saved changes to the relevant sections of Master Document 240 (420). If all verifications are met, Merge Component 400 extracts the content from authorized sections of Sub-Document 250 (422) and saves the content in the corresponding sections of Master Document 240 (424). The extraction of content from Sub-Document 250 includes converting the content to the format required by Master Document 240. Conversion software is known in the art, and is included as part of most word processing applications. Merge. Component 400 saves information containing the date and time stamp of Sub-Document 250 in the metadata of Master Document 240 (426). After updating Master Document 240, or if any of the verifications (416420) fail, Merge Component 400 stops (428).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer program product comprising a computer useable medium having a computer readable program, wherein the computer readable prop=a when executed on a computer causes the computer to:
identify an author of a sub-document;
read metadata from master document, wherein the metadata specifies an authorized author for the sub-document;
compare the author to the authorized author, and
merge the sub-document into the master document only if the author is identical to the authorized author.

2. The computer program product of claim 1 wherein the sub-document is a chat transcript

3. The computer program product of claim 1 wherein the sub-document is an email message.

4. The computer program product of claim 1 wherein the metadata comprises extensible markup language elements.

5. A computer-implemented process for merging a sub-document into a master document, the process comprising:
identifying an author of the sub-document;
reading metadata that specifies an authorized author of the sub-document,
comparing the author to the authorized author, and
merging the sub-document into the master document only if the author is identical to the authorized author.

6. The computer-implemented process of claim 7 wherein the sub-document is a chat transcript.

7. The computer-implemented process of claim 7 wherein the sub-document is an email message.

8. The Computer-implemented process of claim 7 wherein the metadata comprises extensible markup language elements.

9. A computer comprising:
a processor,
a memory coupled to the processor, and
a computer program in the memory operable to cause the processor to
identify an author of a sub-document,
read metadata from a master document, wherein the metadata specifies an authorized author for the sub-document,
compare the author to the authorized author, and
merge the sub-document into the master document only if the author is identical to the authorized author.

10. The computer of claim 9 wherein the sub-document is a chat transcript.

11. The computer of claim 9 wherein the sub-document is an email message.

12. The computer of claim 9 wherein the metadata comprises extensible markup language elements.
